(19) United States
(12) Patent Application Publication
(10) Pub. No.: US 2013/0030134 A1
(43) Pub. Date: Jan. 31, 2013

(54) ZIEGLER CATALYST AND METHOD OF SYNTHESIZING THE SAME

(71) Applicants: Nona Ghasemi Hamedani, TEHRAN (IR); Mina Behroozi Fard Moghaddam, TEHRAN (IR); Reza Marandi, TEHRAN (IR); Farideh Azimfar, TERHAN (IR); Sadegh Abedi, TEHRAN (IR)

(72) Inventors: Nona Ghasemi Hamedani, TEHRAN (IR); Mina Behroozi Fard Moghaddam, TEHRAN (IR); Reza Marandi, TEHRAN (IR); Farideh Azimfar, TERHAN (IR); Sadegh Abedi, TEHRAN (IR)

(73) Assignee: PETROCHEMICAL RESEARCH AND TECHNOLOGY COMPANY, TEHRAN (IR)

(21) Appl. No.: 13/194,948

(22) Filed: Jul. 31, 2011

(51) Int. Cl. C08F 4/656; C08F 4/64; C08F 4/649

(52) U.S. Cl. 526/124.5; 502/119; 502/104; 526/159

(57) ABSTRACT

The various embodiments herein disclose a method for making a Zieglaer catalyst including a reaction product of a dispersed magnesium alkoxide or a dispersed mixture of magnesium alkoxide and silica with a transition metal compound of titanium, zirconium, vanadium or chromium, and a chlorine containing organoaluminum mixed together with two additional components comprising a halogen containing silicon compound and aliphatic primary halogenated hydrocarbons respectively. The embodiments also provide a method of polymerization of 1-olefin monomers using the Ziegler catalyst.

### BACKGROUND

1. Technical Field

The embodiments herein generally relate to the field of polymer production and particularly to a production of polymers such as poly-1-olefin homopolymers and copolymers in presence of catalysts and more particularly to a Ziegler catalyst and its preparation method.

2. Description of the Related Art

A large number of catalysts of the Ziegler type for the polymerization of olefins are already known. Many of these catalysts obtained by reacting a magnesium compound used as a carrier, such as a magnesium halide, commercially available magnesium alkoxide, etc with a titanium halide constitute a compound of a highly active catalyst for the polymerization of ethylene. Examples of such catalyst systems are shown in U.S. Pat. Nos. 3,574,138; 4,316,966 and 5,173,465. With these catalyst components, however, satisfactory catalyst activity and polyethylene of the desired quality are not obtained. Therefore, various methods have been proposed to obtain the improved results.

It has been disclosed in U.S. Pat. No. 4,400,302 that Ziegler catalyst having high activity has been produced in which magnesium alkoxide, after being treated with a halohydrocarbon, is reacted with a titanium compound. The halogenated reaction product may be modified by reacting with an electron donor. As compared with the catalyst compositions that have been proposed in the prior art and which are prepared by halogenating magnesium compounds with a titanium tetra halide, the presence of the halohydrocarbon during halogenations of the magnesium compound brings about an unexpected increase in the polymerization activity of the resulting catalyst compositions.

Furthermore a method for producing a Ziegler catalyst has been disclosed in U.S. Pat. No. 4,255,544 in which magnesium di-alkoxide is pre-treated with a specific amount of silicon compound in the presence of an alcohol and then the solid material so obtained is reacted with a titanium halide in the presence of a silicon compound. This process has greatly increased the catalytic activity and the polymer produced using this catalyst component has excellent bulk density and powder particle size characteristics.

It has also been disclosed in U.S. Pat. Nos. 5,917,100 and 5,648,309 that with a conversion of commercial magnesium alkoxide suspension in a saturated hydrocarbon or hydrocarbon mixtures to magnesium alkoxide dispersion by means of a high speed mixer, it is possible to obtain catalysts with good hydrogen response and high activity even in the presence of molecular weight regulators such as hydrogen.

But, all of the above methods do not control the particles size distribution and the shape of the particle of the polymer powder produced.

Hence there is a need for a simple method of synthesis of Ziegler catalyst for effectively controlling a particle size distribution and a particle shape of a synthesized polymer powder.

The above mentioned shortcomings, disadvantages and problems are addressed herein and which will be understood by reading and studying the following specification.

### OBJECTS OF THE EMBODIMENTS

The primary object of the embodiments herein is to provide a new method for a preparation of a Ziegler catalyst firstly by a reaction of a dispersed magnesium alkoxide or its combination with silica with a halohydrocarbon and then reacting it by a transition metal compound and an organoaluminum compound in the presence of a silicon compound.

Another object of the embodiments herein is to provide a method for a preparation of a Ziegler catalyst wherein the chemically modified catalysts display high polymerization activity for producing polyolefines with uniform particles and high molecular weight.

Yet another object of the embodiments herein is to provide a method for the preparation of a Ziegler catalyst wherein the method makes it possible to control the particle size distribution and the particle shape of the particles of the powder polymer produced.

Yet another object of the embodiments herein is to provide a method for producing a Ziegler catalyst with high activity and high hydrogen response.

Yet another object of the embodiments herein is to provide a Ziegler catalyst for preparing 1-olefin homopolymers and copolymers by polymerization process.

Yet another object of the embodiments herein is to provide a Ziegler catalyst with a narrow particle size distribution and produce high molecular weight polymers.

These and other objects and advantages of the embodiments herein will become readily apparent from the following detailed description taken in conjunction with the accompanying drawings.

### SUMMARY

The various embodiments herein provide a method for making a supported olefin polymerization catalyst, including a reaction product of a dispersed magnesium alkoxide or a dispersed mixture of magnesium alkoxide and silica (component a) with a transition metal compound of titanium, zirconium, vanadium or chromium (component b), a chlorine containing organoaluminum (component c) together with two additional components (d) and (e). Component (d) comprising a halogen containing silicon compound represented by formula XₙSi(OR²)₄₋ₙ wherein X is a halogen atom, R² is an alkyl group and 0<n≦4. Component (e) comprising aliphatic primary halogenated hydrocarbons comprise from 1 to 12, particularly less than 9 carbon atoms and at least two halogen atoms.

The embodiments herein provide a Ziegler catalyst. The Ziegler catalyst comprises a reaction product of a dispersed magnesium alkoxide or a dispersed mixture of magnesium alkoxide and silica (component a) with a transition metal compound comprising of titanium, zirconium, vanadium or chromium metal (component b), a chlorine containing organoaluminum (component c) together with at least two additional components, component (d) and component (e). The component (d) includes a halogen containing silicon compound represented by a formula XₙSi(OR²)₄₋ₙ wherein X is a halogen atom, wherein R² is an alkyl group, wherein n is 0<n≦4, and wherein the component (d) is selected from a group comprising of SiCl₄, Si(OCH₃)Cl₃, and Si(OC₂H₅)₂Cl₂. The component (e) includes aliphatic primary halogenated hydrocarbons, wherein the component (e) is selected from a group comprising of CCl₄, CHCl₃, CH₂Cl₂, CH₃CCl₃, CH₂ClC₂H₅, benzyl chloride and combination thereof, and wherein the component (e) is CCl₄, CHCl₃.

The magnesium alkoxide in component (a) in embodiments herein is represented by the formula Mg(OR₃)(OR₄) in which R₃ and R₄ are selected from a group comprising of alkyl, alkenyl, cycloalkyl, aryl groups, wherein the aryl groups having 1 to 20 carbon atoms, preferably 1 to 10 carbon atoms, and identical or different and wherein R₃ and R₄ may be same or different and wherein the magnesium alkoxide is selected from a group comprising of Mg(OCH₃)₂, Mg(OC₂H₅)₂, Mg(OCH₃)(OC₂H₅), Mg(Oi-C₃H₇)₂, Mg(OC₃H₇)₂, Mg(OC₄H₉)₂, Mg(Oi-C₄H₉)₂, Mg(OC₄H₉)(O-iC₄H₉), Mg(OC₄H₉)—(Osec-C₄H₉), Mg(OC₆H₁₃)₂, Mg(OC₈H₁₇)₂, Mg(OC₆H₁₁)₂, Mg(OC₆H₅)₂, Mg(OC₆H₄CH₃)₂ and Mg(OCH₂C₆H₅)₂, wherein the magnesium alkoxide is Mg(OC₂H₅)₂, Mg(O-n-C₃H₇)₂ and Mg(O-i-C₃H₇)₂.

Examples of component (b) include TiCl₄, Ti(OR²)₄, Zr(OR²)₄, VCl₄, VOCl₃, CrO₂Cl₂, preferably TiCl₄. The component (b) in the embodiments is TiCl₄ or Ti (OR²)₄.

The component (c) is selected from a group comprising of a dialkyl aluminum monochloride and an alkyl aluminum sesquichloride, wherein the dialkyl aluminum monochloride has a formula R⁵₂AlCl and wherein the alkyl aluminum sesquichloride has a formula R⁵₃Al₂Cl₃ wherein R⁵ is an alkyl radical having from 1 to 10 carbon atoms, wherein the component (c) is (C₂H₅)₃Al₂Cl₃ or (C₇H₅)₇AlCl or their mixtures.

According to another embodiment herein, a method of synthesizing a Ziegler catalyst is given. The method includes preparing a support. The support is in the form of a gel-like dispersion. The gel-like dispersion is prepared by dispersing the suspension of magnesium alkoxide or its mixture with silica in an inert hydrocarbon by a high speed homogenizer. The speed rate of high speed homogenizer is from 10000 to 20000 rpm. The mixture is homogenized for a period of 3 to 7 hours at a temperature of 10° C. to 50° C. The gel-like dispersion is also could be prepared by milling the magnesium alkoxide or its mixture with silica to a particular mean particle size in a jet mill under inert condition. It is then be suspended in a hydrocarbon media and converted into the gel like dispersion by stirring at 50-200 rpm for 15-30 h. An aliphatic primary halogenated hydrocarbon (component e) is added to the above support and reacted with the component (a) of the prepared support at a temperature from 30 to 90° C. over a period of 0.5 to 5 hours. The concentration of component (b) is in a ratio of 0.05 to 1 mol per mol of the magnesium alkoxide. A transition metal compound (component b) is then added. The transition metal compound (component b) is added at a temperature of 60 to 120° C. in the presence of the inert hydrocarbon while stirring for 1 to 5 hours. The stirring is done in a range of 50 to 300 rpm. The concentration of component (e) added is of 0.05 to 3 mol per 1 mol of magnesium alkoxide. A chlorine containing organoaluminium (component c) is then added at a temperature from 80 to 140° C. over a period of 0.5 to 4 hours in a ratio of 0.5 to 3 mol of aluminum per mol of magnesium. Then a halogen containing silicon compound (component d) is added. The halogen containing silicon compound (component d) is added at a temperature from 40 to 100° C. over a period of 1 to 6 hours in a ratio of 0.05 to 2 mol per mol of magnesium alkoxide and the Ziegler catalyst is obtained.

According to another embodiment herein, the Ziegler catalyst polymerises 1-olefin and produces homopolymers and copolymers. The 1-olefin has a formula R¹CH═CH₂ wherein R¹ is hydrogen or alkyl radical having from 1 to 10 carbon atoms.

The inert hydrocarbon in the embodiments is selected from a group comprising of an aliphatic or cyclo-aliphatic hydrocarbon, an aromatic hydrocarbon, a hydrogenated diesel oil fraction, or petroleum spirit fraction which are essentially free of oxygen, sulfur compound and moisture and combination and mixture thereof. The inert hydrocarbon is heptanes, nonane, toluene and combination thereof.

The gel-like dispersion has an average particle diameter of less than 10 μm. The order of addition of components (d) and (e) or their mixture in the method can be varied.

The magnesium alkoxide in component (a) is represented by the formula Mg(OR³)(OR⁴) in which R³ and R⁴ are selected from a group comprising of an alkyl, an alkenyl, a cycloalkyl, and an aryl group, wherein the alkyl, the alkenyl, the cycloalkyl, and the aryl group have 1 to 20 carbon atoms, wherein the carbon atoms are 1 to 10 carbon atoms, and identical or different and wherein R³ and R⁴ may be the same or different and wherein the magnesium alkoxide is selected from a group comprising of Mg(OCH₃)₂, Mg(OC₂H₅)₂, Mg(OCH₃)(OC₂H₅), Mg(Oi-C₃H₇)₂, Mg(OC₃H₇)₂, Mg(OC₄H₉)₂, Mg(Oi-C₄H₉)₂, Mg(OC₄H₉)(O-iC₄H₉), Mg(OC₄H₉)—(Osec-C₄H₉), Mg(OC₆H₁₃)₂, Mg(OC₈H₁₇)₂, Mg(OC₆H₁₁)₂, Mg(OC₆H₅)₂, Mg(OC₆H₄CH₃)₂ and Mg(OCH₂C₆H₅)₂, wherein the magnesium alkoxide is Mg(OC₂H₅)₂, Mg(O-n-C₃H₇)₂ and Mg(O-i-C₃H₇)₂.

Silica in component (a) is represented by the formula SiO₂. It is one of the common inorganic oxides which are commercially available and are used in Ziegler Natta catalysts. The silica exhibits a particle size between 1 to 300 μm and more preferably from 30 to 70 μm. It is activated at temperature between 400 to 1000° C. under inert atmosphere and then its mixture with magnesium ethoxide is dispersed in an inert hydrocarbon or hydrocarbon mixtures.

The component (b) in the embodiments is TiCl₄ or Ti (OR²)₄.

The component (c) is selected from a group comprising of a dialkyl aluminum monochloride and an alkyl aluminum sesquichloride, wherein the dialkyl aluminum monochloride has a formula R⁵₂AlCl and wherein the alkyl aluminum sesquichloride has a formula R⁵₃Al₂Cl₃ wherein R⁵ is an alkyl radical having from 1 to 10 carbon atoms, wherein the component (c) is (C₂H₅)₃Al₂Cl₃ or (C₂H₅)₂AlCl or their mixtures.

The component (d) includes a halogen containing silicon compound represented by a formula XₙSi(OR²)₄₋ₙ wherein X is a halogen atom, wherein R² is an alkyl group, wherein n is 0<n≦4, and wherein the component (d) is selected from a group comprising of SiCl₄, Si(OCH₃)Cl₃, and Si(OC₂H₅)₂Cl₂.

The component (e) includes aliphatic primary halogenated hydrocarbons, wherein the component (e) is selected from a group comprising of CCl₄, CHCl₃, CH₂Cl₂, CH₃CCl₃, CH₂ClC₂H₅, benzyl chloride and combination thereof, and wherein the component (e) is CCl₄, CHCl₃.

According to another embodiment herein, the Ziegler catalyst is used to synthesize homopolymers and copolymers by polymerization, wherein the step of polymerization carried out in presence of the Ziegler catalyst along with a co-catalyst. The polymerization is carried out at a temperature of 50 to 120° C. and at a pressure of 2 to 20 bars. The temperature is 70 to 90° C. The homopolymers and copolymers are synthesized from a monomer, wherein the monomer is 1-olefin, wherein the 1-olefin has a formula R¹CH═CH₂, where R¹ is hydrogen or an alkyl radical having from 1 to 10 carbon atoms.

The co-catalyst is a chlorine free organoaluminum having a formula AlR⁶₃, wherein R⁶ is an alkyl radical having from 1 to 16 carbon atoms, wherein the co-catalyst is selected from a group comprising of Al(C₂H₅)₃, Al(C₃H₇)₃, Al(iC₄H₉)₃, Al(C₈H₁₇)₃, Al(C₁₂H₂₅)₃, Al(C₂H₅)(Cl₂H₂₅)₂ and Al(iC₄H₉)(C₁₂H₂₅)₂, and wherein the co-catalyst is Al (C₂H₅)₃.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The other objects, features and advantages will occur to those skilled in the art from the following description of the preferred embodiment and the accompanying drawings in which:

FIG. 1 illustrates a block diagram showing the general steps of the method of synthesis of the Ziegler catalyst, according to one embodiment herein.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### DETAILED DESCRIPTION OF THE EMBODIMENTS

In the following detailed description, a reference is made to the accompanying drawings that form a part hereof, and in which the specific embodiments that may be practiced is shown by way of illustration. The embodiments are described in sufficient detail to enable those skilled in the art to practice the embodiments and it is to be understood that the logical, mechanical and other changes may be made without departing from the scope of the embodiments. The following detailed description is therefore not to be taken in a limiting sense.

The embodiments herein provide a process for the preparation of a Ziegler catalyst firstly by reaction of dispersed magnesium alkoxide or its combination with silica with a halohydrocarbon and then reacting by a transition metal compound and an organoaluminum compound in the presence of a silicon compound. In the process, the chemically modified catalysts display high polymerization activity for producing polyolefines with uniform particles and high molecular weight.

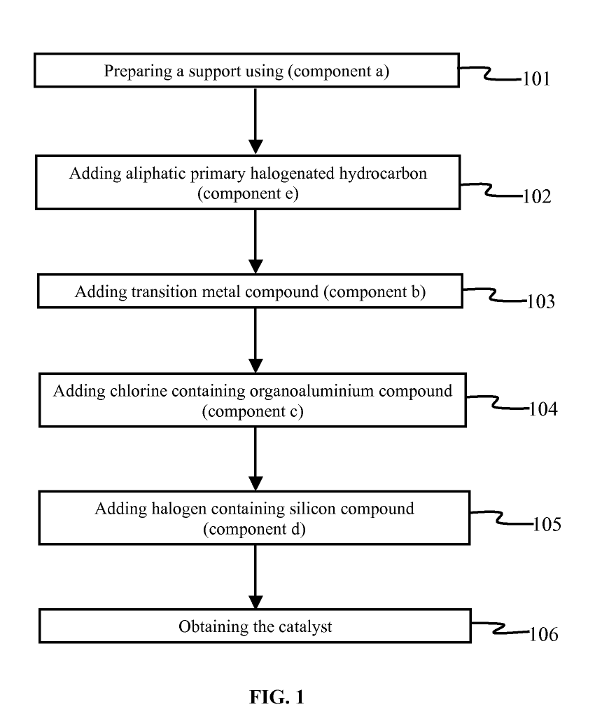

FIG. 1 illustrates a block diagram showing the general steps of the method of synthesis of the Ziegler catalyst, according to one embodiment herein. With respect to FIG. 1, the method comprises of preparing a support using (component a) (101). The (component a) comprises of dispersed magnesium alkoxide or a dispersed mixture of magnesium alkoxide and silica. The magnesium alkoxide in component (a) is represented by the formula Mg(OR³)(OR⁴) in which R³ and R⁴ are selected from a group comprising of alkyl, alkenyl, cycloalkyl, aryl groups, wherein the aryl groups having 1 to 20 carbon atoms, preferably 1 to 10 carbon atoms, and identical or different and wherein R³ and R⁴ may be same or different and wherein the magnesium alkoxide is selected from a group comprising of Mg(OCH₃)₂, Mg(OC₂H₅)₂, Mg(OCH₃)(OC₂H₅), Mg(Oi-C₃H₇)₂, Mg(OC₃H₇)₂, Mg(OC₄H₉)₂, Mg(Oi-C₄H₉)₂, Mg(OC₄H₉)(O-iC₄H₉), Mg(OC₄H₉)—(Osec-C₄H₉), Mg(OC₆H₁₃)₂, Mg(OC₈H₁₇)₂, Mg(oc₆H₁₁)₂, Mg(OC₆H₅)₂, Mg(OC₆H₄CH₃)₂ and Mg(OCH₂C₆H₅)₂, wherein the magnesium alkoxide is Mg(OC₂H₅)₂, Mg(O-n-C₃H₇)₂ and Mg(O-i-C₃H₇)₂. The support is in the form of a gel-like dispersion. The gel-like dispersion is prepared by dispersing the suspension of magnesium alkoxide or its mixture with silica in an inert hydrocarbon by a high speed homogenizer. The speed rate of high speed homogenizer is from 10000 to 20000 rpm. The mixture is homogenized for a period of 3 to 7 hours at a temperature of 10° C. to 50° C. The aliphatic primary halogenated hydrocarbon (component e) is added to the above support (102) and made to react with the component (a) of the prepared support at a temperature from 30 to 90° C. over a period of 0.5 to 5 hours. The concentration of component (e) is in a ratio of 0.05 to 1 mol per mol of the magnesium alkoxide.

The aliphatic primary halogenated hydrocarbons, or the component (e) is selected from a group comprising of CCl₄, CHCl₃, CH₂Cl₂, CH₃CCl₃, CH₂ClC₂H₅, benzyl chloride and combination thereof, and wherein the component (e) is CCl₄, CHCl₃.

Then, a transition metal compound (component b) is added (103). The transition metal compound (component b) is added at a temperature of 60 to 120° C. in the presence of the inert hydrocarbon while stirring for 1 to 5 hours. The stirring is done in a range of 50 to 300 rpm. The concentration of component (b) added is of 0.05 to 3 mol per 1 mol of magnesium alkoxide. The transition metal is selected from a group comprising of titanium, zirconium, vanadium or chromium. The component (b) or the transition metal compound in the embodiments is TiCl₄ or Ti (OR²)₄.

A chlorine containing organoaluminium (component c) is added (104). The chlorine containing organoaluminium (component c) is added at a temperature from 80 to 140° C. over a period of 0.5 to 4 hours in a ratio of 0.5 to 3 mol of aluminum per mol of magnesium. The component (c) is selected from a group comprising of a dialkyl aluminum monochloride and an alkyl aluminum sesquichloride, wherein the dialkyl aluminum monochloride has a formula R⁵₂AlCl and wherein the alkyl aluminum sesquichloride has a formula R⁵₃Al₂Cl₃ wherein R⁵ is an alkyl radical having from 1 to 10 carbon atoms, wherein the component (c) is (C₂H₅)₃Al₂Cl₃ or (C₂H₅)₂AlCl or their mixtures.

Then a halogen containing silicon compound (component d) is added (105) to obtain a catalyst (106). The halogen containing silicon compound (component d) is added at a temperature from 40 to 100° C. over a period of 1 to 6 hours in a ratio of 0.05 to 2 mol per mol of magnesium alkoxide and the Ziegler catalyst is obtained. The component (d) includes a halogen containing silicon compound represented by a formula XₙSi(OR²)₄₋ₙ wherein X is a halogen atom, wherein R² is an alkyl group, wherein n is 0<n≦4, and wherein the component (d) is selected from a group comprising of SiCl₄, Si(OCH₃)Cl₃, and Si(OC₂H₅)₂Cl₂.

The embodiments here provide a Ziegler catalyst for preparing 1-olefin homopolymers and copolymers by polymerization of a 1-olefin of the formula R¹CH═CH₂ where R¹ is hydrogen or alkyl radical having from 1 to 10 carbon atoms in the presence of a catalyst comprising the reaction product of a dispersed magnesium alkoxide or a dispersed mixture of magnesium alkoxide and silica (component a) with a transition metal compound of titanium, zirconium, vanadium or chromium (component b), a chlorine containing organoaluminum (component c) together with two additional components (d) and (e). Component (d) comprising a halogen containing silicon compound represented by formula XₙSi(OR²)₄₋ₙ, wherein X is a halogen atom which chlorine and bromine being preferred, R² is an alkyl group preferably containing from 1 to 8 carbon atoms and 0<n≦4. Component (e) comprising aliphatic primary halogenated hydrocarbons comprise from 1 to 12, particularly less than 9 carbon atoms and at least two halogen atoms.

It is considered that the modification of component (a) with a halohydrocarbon and also use of silicon compound contributes to the remarkable increase in polymer particle uniformity. In addition to the above, the usage of chlorine containing organoaluminum compounds in process of catalyst synthesis leads to increase the catalyst activity and hydrogen response.

Component (a) is produced using a commercially available magnesium alkoxide or its mixture with silica. This magnesium alkoxide is represented by the formula Mg(OR³)(OR⁴) in which R³ and R⁴ are alkyl, alkenyl, cycloalkyl, aryl groups having 1 to 20 carbon atoms, preferably 1 to 10 carbon atoms and identical or different and R³ and R⁴ may be the same or different. These compounds include for example, Mg(OCH₃)₂, Mg(OC₂H₅)₂, Mg(OCH₃)(OC₂H₅), Mg(O-i-C₃H₇)₂, Mg(OC₃H₇)₂, Mg(OC₄H₉)₂, Mg(O-i-C₄H₉)₂, Mg(OC₄H₉)(O-iC₄H₉), Mg(OC₄H₉)(O-sec-C₄H₉), Mg(OC₆H₁₃)₂, Mg(OC₈H₁₇)₂, Mg(OC₆H₁₁)₂, Mg(OC₆H₅)₂, Mg(OC₆H₄CH₃)₂, and Mg(OCH₂C₆H₅)₂. Preferably the use of simple magnesium alkoxide in particular Mg (OC₂H₅)₂, Mg (O-n-C₃H₇)₂ or Mg (O-i-C₃H₇)₂.

Silica in component (a) is represented by the formula SiO₂. It is one of the common inorganic oxides which are commercially available and are used in Ziegler Natta catalysts

The commercially available magnesium alkoxide having a particle diameter in the range from 200 to 1200 μm or its mixture with silica is suspended in an inert hydrocarbon or hydrocarbon mixtures. This suspension is converted to the gel like dispersion by means of a high speed mixer homogenizer (e.g. Polytron—KINEMATICA).

The inert hydrocarbon is an aliphatic or cycloaliphatic hydrocarbon, an aromatic hydrocarbon, a hydrogenated diesel oil fraction, or petroleum spirit fraction that are essentially free of oxygen, sulfur compound and moisture. Suitable inert hydrocarbons are heptane, nonane or toluene.

It may be advantageous for the purpose of the embodiments herein to prepare the gel like dispersion by preparing a suspension of previously milled magnesium alkoxide or its mixture with silica in an inert hydrocarbon and then stirring by for several hours.

The reaction of dispersion or suspension of component (a) by transition metal compound of titanium, zirconium, vanadium or chromium (component b) is usually carried out in a hydrocarbon solvent. Examples of component (b) include TiCl₄, Ti(OR₂)₄, Zr(OR₂)₄, VCl₄, VOCl₃, CrO₂Cl₂, preferably TiCl₄.

An essential feature of embodiments is to react component (a) with at least one aliphatic primary halogenated hydrocarbons (component e) prior to the addition of the transition metal compound. The preferred halogen atom in component (e) is chlorine. Examples of component (e) are alkyl chlorides such as CCl₄, CHCl₃, CH₂Cl₂, CH₃CCl₃, CH₂ClC₂H₅, benzyl chloride. It is also being possible to use their mixtures.

The most preferred reactions are those leading to fully halogenation of component (a). The reaction is most suitably carried out at a temperature of from 30 to 90° C., preferably from 60 to 80° C. in the presence of an inert hydrocarbon. Component (e) is added to component (a) in an amount from 0.05 to 1 mol, preferably from 0.1 to 0.5 mol of the halohydrocarbon per 1 mol of magnesium alkoxide. The reaction time is from 0.5 to 5 hours, preferably from 1 to 4 hours.

Subsequent to halogenation, the product is reacted with transition metal compound (b). The reaction is most suitably carried out at a temperature of from 60 to 120° C., preferably from 70 to 90° C. while stirring at the range of 50 to 300 rpm in the presence of an inert hydrocarbon. Transition metal compound (b) is added in an amount from 0.05 to 3 mol, preferably from 0.1 to 1 mol, per 1 mol of magnesium alkoxide. The reaction time is from 1 to 5 hours, preferably from 2 to 4 hours.

The preparation of the polymerization catalyst to be used according to the embodiments herein is carried out by combining the reaction product of components (a), (e) and (b) with component (c). As component (c) preference is given to using organoaluminum compound. Suitable organoaluminum compounds are chlorine containing organoaluminum, e.g. dialkyl aluminum monochloride of the formula R⁵₂AlCl or an alkyl aluminum sesquichloride of the formula R⁵₃Al₂Cl₃ where R⁵ is an alkyl radical having from 1 to 10 carbon atoms. Preferred Examples are (C₂H₅)₃Al₂Cl₃, (C₂H₅)₂AlCl or their mixtures.

The reaction product of components (a), (e) and (b) with component (c) is carried out at a temperature of from 80 to 140° C., preferably from 100 to 120° C. in the presence of an inert hydrocarbon. Compound (c) is added in an amount from 0.5 to 3 mol, preferably from 1 to 2 mol, per 1 mol of magnesium alkoxide. The reaction time is from 0.5 to 4 hours, preferably from 1 to 3 hours.

For preparing the final polymerization catalyst composition, it is preferable to add the reaction product of components (a), (b), (e) and (c) with component (d) in an inert hydrocarbon. In one preferred embodiment herein component (d) comprises a halogen containing silicon compound, represented by a formula XₙSi(OR²)₄₋ₙ wherein X is a halogen atom preferably chlorine and bromine, R² is an alkyl group containing from 1 to 8 carbon atoms and 0<n≦4. Preferred examples are chlorine containing silicon compound e.g. SiCl₄, SiCl(OCH₃)₃, SiCl₂(OC₂H₅)₂.

This treatment is carried out at a temperature of 40 to 100° C., preferably from 60 to 90° C. in the presence of an inert hydrocarbon. Compound (d) is added in an amount from 0.05 to 2 mol and preferably from 0.1 to 1 mol, per 1 mol of magnesium alkoxide. The reaction time is from 1 to 6 hours, preferably from 2 to 4 hours.

The order in which the above five components are combined with each other is not limited to the mentioned sequence. For example, the components (b), (c) and mixture of components (e) and (d) can be added in succession to component (a). It is also possible to introduce component (d) or its mixture with component (e) to component (a) and subsequently components (b) and (c) can be added.

According to an embodiment herein, the catalyst may be used for the homopolymerization or copolymerization of olefins of the formula R¹CH═CH₂ in which R¹ is a hydrogen atom or an alkyl radical having 1 to 10 carbon atoms, for example ethylene, propylene, 1-butene or 1-hexane.

There is no limitation of polymerization type and any one of solution, suspension or gas phase polymerization, continuously or batchwise, could be employed. Further, the polymerization could be carried out under different condition in two step or multi step polymerization.

It is preferred to use a catalyst synthesized above directly or after prepolymerization in slurry phase using as diluent an inert hydrocarbon solvent. Prepolymerization is carried out by contacting the final catalyst component by olefin in order to form a prepolymerized catalyst component comprising from about 20 weight to about 100 weight percent prepolymer.

The polymerization is generally carried out within a pressure range of 2 to 20 bars and at a temperature of 50 to 120° C., preferably from 70 to 90° C.

The molecular weight of the polymer is regulated, preferably by using hydrogen as transfer agent.

The cocatalyst used herein is a chlorine free organoaluminum compound represented by formula AlR⁶₃ in which R⁶ is an alkyl radical having from 1 to 16 carbon atoms. Examples are Al(C₂H₅)₃, Al(C₃H₇), Al(iC₄H₉)₃, Al(C₈H₁₇)₃, Al(C₁₂H₂₅)₃, Al(C₂H₅)(C₁₂H₂₅)₂ and Al(iC₄H₉)(C₁₂H₂₅)₂. Preference is given to Al(C₂H₅)₃. The concentration of cocatalyst used is 1 molar solution of triethyl aluminum in heptanes.

According to the embodiments herein, the catalyst produced is of high activity and high hydrogen response. The obtained polymer particles have narrow particle size distribution also the polymers have high molecular weight.

It is considered that the modification of component (a) with a halohydrocarbon and also use of silicon compound contributes to the remarkable increase in polymer particle uniformity. In addition, using chlorine containing organoaluminum compounds in process of catalyst synthesis leads to increase in catalyst activity and hydrogen response.

According to the embodiments herein, the Ziegler catalyst for preparing 1-olefin homopolymers and copolymers by polymerization of a 1-olefin of the formula R¹CH═CH₂ where R¹ is hydrogen or alkyl radical having from 1 to 10 carbon atoms in suspension and in the presence of a catalyst comprising the reaction product of a dispersed magnesium alkoxide or dispersed mixture of magnesium alkoxide and silica (component a) with a transition metal compound of titanium, zirconium, vanadium or chromium (component b), a chlorine containing organoaluminum (component c) together with two additional components (d) and (e). Component (d) comprising a halogen containing silicon compound represented by formula XₙSi(OR²)₄₋ₙ wherein X is a halogen atom, R² is an alkyl group and 0<n≦4. Component (e) comprising aliphatic primary halogenated hydrocarbons. The magnesium alkoxide in component (a) is represented by the formula Mg(OR³)(OR⁴) in which R³ and R⁴ are alkyl, alkenyl, cycloalkyl, aryl groups having 1 to 20 carbon atoms, preferably 1 to 10 carbon atoms, and identical or different and R³ and R⁴ may be the same or different. The alkoxide is Mg(OCH₃)₂, Mg(OC₂H₅)₂, Mg(OCH₃)(OC₂H₅), Mg(Oi-C₃H₇)₂, Mg(OC₃H₇)₂, Mg(OC₄H₉)₂, Mg(Oi-C₄H₉)₂, Mg(OC₄H₉)(OiC₄H₉), Mg(OC₄H₉)—(Osec-C₄H₉), Mg(OC₆H₁₃)₂, Mg(OC₈H₁₇)₂, Mg(OC₆H₁₁)₂, Mg(OC₆H₅)₂, Mg(OC₆H₄CH₃)₂, and Mg(OCH₂C₆H₅)₂. Preference is given for using the simple magnesium alkoxide in particular Mg(OC₂H₅)₂, Mg(O-n-C₃H₇)₂ or Mg(O-i-C₃H₇)₂. The component (b) is TiCl₄ or Ti (OR²)₄. The component (d) is SiCl₄, Si(OCH₃)Cl₃, Si(OC₂H₅)₂Cl₂. The component (e) is CCl₄, CHCl₃, CH₂Cl₂, CH₃CCl₃, CH₂ClC₂H₅, benzyl chloride. It is also possible to use their mixtures. Preference is given to use CCl₄, CHCl₃. The component (c) is an organoaluminum compound of particularly a chlorine containing organoaluminum compound such as a dialkyl aluminum monochloride of the formula R⁵₂AlCl or an alkyl aluminum sesquichloride of the formula R⁵₃Al₂Cl₃ where R⁵ is an alkyl radical having from 1 to 10 carbon atoms. The chlorine containing organoaluminum (component c) is (C₂H₅)₃Al₂Cl₃ or (C₂H₅)₂AlCl or their mixtures.

According to an embodiment herein, component (a) is obtained by subjecting a suspension of magnesium alkoxide or its mixture with silica in an inert condition by a high speed homogenizer using speed rate from 10000 to 20000 rpm for a period of 3 to 7 hours at a temperature from 10 to 50° C. to convert a suspension to a gel-like dispersion. The obtained gel-like dispersion has an average particle diameter of less than 10 μm.

The gel-like dispersion is also could be prepared by milling the magnesium alkoxide or its mixture with silica to a particular mean particle size in a jet mill under inert condition. It is then be suspended in a hydrocarbon media and converted into the gel like dispersion by stirring at 50-200 rpm for 15-30 h.

According to another embodiment herein, a process for preparing a Ziegler catalyst is provided. The method comprises reacting the component (a) with the titanium compound (component b) at a temperature range of 60 to 120° C., in the presence of an inert hydrocarbon while stirring at the range of 50 to 300 rpm, with from 0.05 to 3 mol of component (b) being used per 1 mol of magnesium alkoxide for 1 to 5 hours, wherein component (e) or component (d) or a mixture of them is added.

The inert hydrocarbon is an aliphatic or cycloaliphatic hydrocarbon, an aromatic hydrocarbon, a hydrogenated diesel oil fraction, or petroleum spirit fraction, wherein the hydrogenated diesel oil fraction or petroleum spirit fraction are essentially free of oxygen, sulfur compound, and moisture. The inert hydrocarbon is heptane, nonane or toluene. The reaction of component (e) is carried out at a temperature ranging from 30 to 90° C. over a period of 0.5 to 5 hours in a ratio of 0.05 to 1 mol per mol of magnesium alkoxide.

The reaction of component (d) is carried out at a temperature ranging from 40 to 100° C. over a period of 1 to 6 hours in a ratio of 0.05 to 2 mol per mol of magnesium alkoxide. The reaction product of component (a), component (b), component (e) and component (d) or its mixture, is reacted with component (c), chlorine containing organoaluminum compound.

The order of addition of components (d) and (e) or their mixture could be varied. The reaction of chlorine containing organoaluminum component (c) is carried out at a temperature ranging from 80 to 140° C. over a period of 0.5 to 4 hours in a ratio of 0.5 to 3 mol of aluminum per mol of magnesium.

According to one embodiment herein, the process for preparing 1-olefin homopolymers and copolymers by polymerization of a 1-olefin of the formula R¹CH═CH₂, where R¹ is hydrogen or an alkyl radical having from 1 to 10 carbon atoms, in a suspension in the presence of the catalyst, where the catalyst is combined with a cocatalyst at a temperature ranging from 50 to 120° C., preferably from 70 to 90° C. and a pressure in the range from 2 to 20 bars The catalyst could be added in a prepolymerized state to the polymerization reaction. The cocatalyst is Al (C₂H₅)₃.

The following examples and comparative example are given to explain the embodiments in greater details. The following examples in no matter limit the scope of the invention.

### Example 1

### Preparation of Support

Mixture of 1.5 mol commercially Mg(OC₂H₅)₂ (having a particle diameter in the range of 200 to 1200 μm and 1500 ml heptane has been dispersed by high speed homogenizer) (e.g. Polytron—KINEMATICA) using speed rate around 15000 rpm for a period of 6 hours in a 3000 ml reactor under protective gas (N₂, grade 5.5). The vessel needs to be cooled and kept temperature around 30° C.

The average particle diameter of Mg(OC₂H₅)₂ dispersion prepared is ≦10 μm.

Preparation of Catalyst:

127 ml magnesium ethoxide/heptane dispersion (0.15 mol Mg(OC₂H₅)₂ (in a 1000 ml reactor with impeller stirrer and protective gas (N₂, grade 5.5) was diluted with heptane to a total volume of 160 ml and this was stirred in room temperature for 30 min.

The mixture was heated to 60° C. At this temperature and stirring rate of 150 rpm, 0.02 mol CCl₄ in heptane were added drop wise at a uniform rate over a period of 1.5 hours. After an after-reaction time of 2 hours, the temperature was raised to 85° C., and 0.03 mol of TiCl₄ in 50 ml heptane was metered in over period of 4 hours at a stirrer speed of 150 rpm. After an after-reaction time of 0.5 hours, the temperature was raised to 100° C., and 0.15 mol Al (C₂H₅)₂Cl in 55 ml heptane was metered in over a period of 2 hours.

After a further 2 hours, the suspension was cooled. After cooling to 50° C., the catalyst was freed of soluble residual material by decanting and refilling the supernatant clear solution four times. The molar ratio of the catalyst component was: Mg:Ti:Al:Cl=1:0.40:0.29:2.27

### Example 2

The preparation of the support and solid catalyst component of Example 1 was repeated, with exception that 0.04 mol CCl₄ was added.

The molar ratio of the catalyst component was: Mg:Ti:Al:Cl=1:0.46:0.29:2.64

### Example 3

The preparation of the support and solid catalyst component of Example 1 was repeated, with exception that 0.05 mol CCl₄ was added.

The molar ratio of the catalyst component was: Mg:Ti:Al:Cl=1:0.42:0.16:2.70

### Example 4

The preparation of the support and solid catalyst component of Example 1 was repeated, with exception that 0.01 mol CCl₄ was added.

The molar ratio of the catalyst component was: Mg:Ti:Al:Cl=1:0.44:0.26:2.54

### Example 5

The preparation of the support and catalyst was carried out by the method described in Example 1 except that 0.01 mol SiCl₄ in 50 ml heptane was carried out only in the last step after the addition of Al(C₂H₅)₂Cl. The addition was metered at 85° C. in over a period of 2 hours and an after-reaction time of 2 hours was employed.

The molar ratio of the catalyst component was: Mg:Ti:Al:Cl:Si=1:0.37:0.25:2.37:0.02

### Example 6

The preparation of the support and catalyst was carried out by the method described in Example 1 except that 0.015 mol SiCl₄ in 50 ml heptane was carried out only in the last step after the addition of Al(C₂H₅)₂Cl. The addition was metered at 85° C. in over a period of 2 hours and an after-reaction time of 2 hours was employed.

The molar ratio of the catalyst component was: Mg:Ti:Al:Cl:Si=1:0.31:0.32:2.4:0.02

### COMPARATIVE EXAMPLE 1

210 ml magnesium ethoxide/heptane dispersion (0.16 mol Mg(OC₂H₅)₂ (in a 1000 ml reactor with impeller stirrer and protective gas (N2, grade 5.5) was diluted with heptane to a total volume of 160 ml and this was stirred in room temperature for 30 min.

The temperature was raised to 85° C., and 0.05 mol of TiCl₄ in 65 ml heptane was metered in over period of 4 hours at a stirrer speed of 150 rpm. After an after-reaction time of 0.5 hours, the temperature was raised to 110° C., and 0.12 mol Al₂(C₂H₅)₃Cl₂ in 137 ml heptane was metered in over a period of 2 hours.

After a further 2 hours, the suspension was cooled to 85° C. and 0.016 mol of the SiCl₄ was added to 66 ml heptane over a period of 2 hours and after a further 2 hours the suspension was cooled to 50° C. The catalyst was freed of soluble residual material by decanting and refilling the supernatant clear solution four times.

The molar ratio of the catalyst component was: Mg:Ti:Al:Cl:Si=1:0.34:0.38:2.1:0.02

### Example 7

Polymerization experiments using the catalysts from examples 1 to 5 and comparative example.

The polymerization experiments were carried out in a 1000 ml reactor. The temperature in the reactor was measured and automatically kept constant. The polymerization temperature was 83±1° C.

The polymerization reaction was carried out in the following manner:

500 ml of heptane were placed in the reactor under an N₂-blanket and heated to 83° C. In the next step, 1 mmol of Al(C₂H₅)₃ as cocatalyst and then the catalysts prepared as described in above examples (Example 1 to example 6 and comparative example 1) in an amount corresponding to 0.01 mmol of titanium as a suspension diluted with heptane were introduced into the reactor.

The reactor was then pressurized with 3.5 bars of hydrogen and 5 bars of ethylene. The total pressure of 8.5 bars was kept constant during the polymerization time by replacing the ethylene which had been consumed.

The polymerization was stopped after 1 hour and the pressure was read off. Then the solid was allowed to settle and the supernatant was decanted. In the final step the solid was dried.

The reported results on the elemental composition of the catalysts described were obtained by conventional analytical methods. The average particle diameter d₅₀ and the proportion of fine<100 μm of polymer powders were determined by laser diffraction analysis in accordance with DIN 66144. The results of the polymerizations are shown in table 1.

TABLE 1 SHOWING THE VARIOUS PARAMETERS AFTER POLYMERIZATION

Polymerization experiments in 1000 ml reactor,
1 mmol of Al(C₂H₅)₃, 500 ml heptane, polymerization temperature of 83 ± 1° C.,
3.5 bar of hydrogen, 5 bar of ethylene (total pressure: 8.5 bar).
polymerization time: 1 h

| Catalyst | | | | | | | |
|---|---|---|---|---|---|---|---|
| component | | | | | | | Comparative. |
| from | Ex. 1 | Ex. 2 | Ex. 3 | Ex. 4 | Ex. 5 | EX. 6 | Ex. 1 |
| Polymerization | 5.7 | 6.2 | 9.0 | 8.0 | 10.5 | 8.0 | 9.0 |
| activity¹ | | | | | | | |
| d₅₀ in [μm]² | 210 | 178 | 160 | 159 | 216 | 220 | 182 |
| MFI 190/5 | 14 | 14 | 18 | 22 | 27 | 24 | 25 |
| [gr/10 min]³ | | | | | | | |
| Bulk density | 0.22 | 0.28 | 0.22 | 0.30 | 0.35 | 0.31 | 0.30 |
| [g/ml]⁴ | | | | | | | |
| Proportion of | 5.41 | 10.33 | 4.76 | 2.2 | 3.36 | 6.78 | 1.02 |
| fine particles | | | | | | | |
| <100 μm | | | | | | | |
| [volume in %]2 | | | | | | | |

Notes:
¹Catalyst Productivity (Kg PE/g catalyst)
²Average particle diameter and proportion of fine were determined by laser diffraction analysis in accordance with DIN 66144.
³Melt flow index (MFI 190/5) (gr/10 min) as specified in ASTM1238
⁴Bulk Density (g/ml) as specified in ISO R 60

Mole ratios of elements were tested by conventional analytical methods. The results are shown in Table 2:

TABLE 2 SHOWS THE MOLE RATIOS OF THE VARIOUS COMPONENTS

TABLE 2
SHOWS THE MOLE RATIOS OF THE VARIOUS COMPONENTS

| Mass % | Mass % | Mass % | Mass % | Mass % | Catalyst |
|---|---|---|---|---|---|
| Si | Al | Cl | Mg | Ti | name |
| 0.2 | 4.1 | 42 | 12.6 | 10 | Ex. 1 |
| 0.2 | 3.9 | 45 | 11.8 | 10.4 | Ex. 2 |
| 0.2 | 2.3 | 48 | 12.3 | 10.2 | Ex. 3 |
| 0.2 | 3.5 | 45 | 12.3 | 10.8 | Ex. 4 |
| 0.2 | 3.4 | 43 | 12.5 | 9.1 | Ex. 5 |

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

Although the embodiments herein are described with various specific embodiments, it will be obvious for a person skilled in the art to practice the invention with modifications. However, all such modifications are deemed to be within the scope of the claims.

It is also to be understood that the following claims are intended to cover all of the generic and specific features of the embodiments described herein and all the statements of the scope of the embodiments which as a matter of language might be said to fall there between.

What is claimed is:

1. A Ziegler catalyst comprising:
a reaction product of a component (a), a component (b) and a component (c) together with at least two additional components, wherein the at least two additional components are a component (d) and a component (e);
wherein the component (a) is a dispersed magnesium alkoxide or a dispersed mixture of magnesium alkoxide and silica;
wherein the component (b) is a transition metal compound and wherein the metal component is selected from a group comprising of titanium, zirconium, vanadium and chromium, and wherein the transition metal component (b) is TiCl₄ or Ti (OR²)₄;
wherein the component (c) is a chlorine containing organoaluminum and wherein the component (c) is selected from a group comprising of a dialkyl aluminum monochloride and an alkyl aluminum sesquichloride, and wherein the dialkyl aluminum monochloride has a formula R⁵₂AlCl and wherein the alkyl aluminum sesquichloride has a formula R⁵₃Al₂Cl₃ and wherein R⁵ is an alkyl radical having from 1 to 10 carbon atoms, wherein the component (c) is (C₂H₅)₃Al₂Cl₃ or (C₂H₅)₂AlCl or their mixtures;
wherein the component (d) is a halogen containing silicon compound represented by a formula XₙSi(OR²)₄₋ₙ and wherein X is a halogen atom, and wherein R² is an alkyl group, and wherein n is within a range of 0-4, and wherein the component (d) is selected from a group comprising of SiCl₄, Si(OCH₃)Cl₃, and Si(OC₂H₅)₂Cl₂;
wherein the component (e) is an aliphatic primary halogenated hydrocarbons, and wherein the component (e) is selected from a group comprising of CCl₄, CHCl₃, CH₂Cl₂, CH₃CCl₃, CH₂ClC₂H₅, benzyl chloride and combination thereof, and wherein the component (e) is CCl₄, CHCl₃.

2. The catalyst according to claim 1, wherein the magnesium alkoxide in the component (a) is represented by the formula Mg(OR³)(OR⁴) and wherein R³ and R⁴ are selected from a group comprising of alkyl, alkenyl, cycloalkyl, aryl groups, and wherein the aryl groups has 1 to 20 carbon atoms, and wherein the aryl groups preferably has 1 to 10 carbon atoms, and wherein the alkyl, alkenyl, cycloalkyl, aryl groups are identical or different and wherein R³ and R⁴ are same or different and wherein the magnesium alkoxide is selected from a group comprising of Mg(OCH₃)₂, Mg(OC₂H₅)₂, Mg(OCH₃)(OC₂H₅), Mg(Oi-C₃H₇)₂, Mg(OC₃H₇)₂, Mg(OC₄H₉)₂, Mg(Oi-C₄H₉)₂, Mg(OC₄H₉)(O-iC₄H₉), Mg(OC₄H₉)—(Osec-C₄H₉), Mg(OC₆H₁₃)₂, Mg(OC₈H₁₇)₂, Mg(OC₆H₁₁)₂, Mg(OC₆H₅)₂, Mg(OC₆H₄CH₃)₂ and Mg(OCH₂C₆H₅)₂, and wherein the magnesium alkoxide is Mg(OC₂H₅)₂, Mg(O-n-C₃H₇)₂ and Mg(O-i-C₃H₇)₂.

3. A method of synthesizing a Ziegler catalyst comprising steps of:
preparing a support, wherein the support is in the form of a gel-like dispersion, and wherein the support is made up of a dispersed magnesium alkoxide or a dispersed mixture of magnesium alkoxide and silica;
adding an aliphatic primary halogenated hydrocarbon;
adding a transition metal compound;
adding a chlorine containing organoaluminium; and
adding a halogen containing silicon compound.

4. The method according to claim 3, wherein the support is prepared by dispersing magnesium alkoxide or a mixture of magnesium alkoxide and silica in an inert hydrocarbon by a high speed dispenser-homogenizer, and wherein the high speed dispenser-homogenizer has a speed rate of 10000 rpm to 20000 rpm, and wherein the mixture is homogenized for a period of 3 hours to 7 hours at a temperature of 10° C. to 50° C.

5. The method according to claim 4, wherein the inert hydrocarbon is selected from a group comprising of an aliphatic hydrocarbon, a cycloaliphatic hydrocarbon, an aromatic hydrocarbon, a hydrogenated diesel oil fraction, petroleum spirit fraction and combination and mixtures thereof, and wherein the inert hydrocarbon is essentially free of oxygen, sulfur compound and moisture, and wherein the inert hydrocarbon is heptane, nonane, toluene and combination thereof.

6. The method according to claim 3, wherein the gel-like dispersion has an average particle diameter of less than 10 μm.

7. The method according to claim 3, wherein the aliphatic primary halogenated hydrocarbon is added and reacted with the support at a temperature of 30 to 90° C. over a period of 0.5 to 5 hours, and wherein the aliphatic primary halogenated hydrocarbon is added in a ratio of 0.05 to 1 mol per mol of the magnesium alkoxide.

8. The method according to claim 3, wherein the transition metal compound is added at a temperature of 60 to 120° C. in a presence of an inert hydrocarbon while performing a stirring for 1 to 5 hours, and wherein the stirring is done in a range of 50 to 300 rpm, and wherein the transition metal compound is added in a concentration of 0.05 to 3 mol per 1 mol of magnesium alkoxide.

9. The method according to claim 3, wherein the chlorine containing organoaluminium is added at a temperature of 80 to 140° C. over a period of 0.5 to 4 hours, and wherein the chlorine containing organoaluminium is added in a ratio of 0.5 to 3 mol of aluminum per mol of magnesium alkoxide.

10. The method according to claim 3, wherein the halogen containing silicon compound is added at a temperature of 40 to 100° C. over a period of 1 to 6 hours, and wherein the halogen containing silicon compound is added in a ratio of 0.05 to 2 mol per mol of magnesium alkoxide.

11. The method according to claim 3, wherein an order of addition of the Dispersed magnesium alkoxide or the dispersed mixture of magnesium alkoxide and silica, the aliphatic primary halogenated hydrocarbon, the transition metal compound, the chlorine containing organoaluminium, and the halogen containing silicon compound or their mixture is varied.

12. The method according to claim 3, wherein the magnesium alkoxide is represented by the formula Mg(OR³)(OR⁴) wherein R³ and R⁴ are selected from a group comprising of an alkyl, an alkenyl, a cycloalkyl, and an aryl group, and wherein the alkyl, the alkenyl, the cycloalkyl, and the aryl group has 1 to 20 carbon atoms, and wherein the alkyl, the alkenyl, the cycloalkyl, and the aryl group has 1 to 10 carbon atoms, and wherein the alkyl, the alkenyl, the cycloalkyl, and the aryl group are identical or different and wherein R³ and R⁴ are same or different and wherein the magnesium alkoxide is selected from a group comprising of Mg(OCH₃)₂, Mg(OC₂H₅)₂, Mg(OCH₃)(OC₂H₅), Mg(Oi-C₃H₇)₂, Mg(OC₃H₇)₂, Mg(OC₄H₉)₂, Mg(Oi-C₄H₉)₂, Mg(OC₄H₉)(O-iC₄H₉), Mg(OC₄H₉)—(Osec-C₄H₉), Mg(OC₆H₁₃)₂, Mg(OC₈H₁₇)₂, Mg(OC₆H₁₁)₂, Mg(OC₆H₅)₂, Mg(OC₆H₄CH₃)₂ and Mg(OCH₂C₆H₅)₂, and wherein the magnesium alkoxide is Mg(OC₂H₅)₂, Mg(O-n-C₃H₇)₂ and Mg(O-i-C₃H₇)₂.

13. The method according to claim 3, wherein the aliphatic primary halogenated hydrocarbon includes aliphatic primary halogenated hydrocarbons, and wherein the component (e) is selected from a group comprising of CCl₄, CHCl₃, CH₂Cl₂, CH₃CCl₃, CH₂ClC₂H₅, benzyl chloride and combination thereof, and wherein the component (e) is CCl₄, CHCl₃.

14. The method according to claim 3, wherein the transition metal compound is TiCl₄ or Ti (OR²)₄.

15. The method according to claim 3, wherein the chlorine containing organoaluminium is selected from a group comprising of a dialkyl aluminum monochloride and an alkyl aluminum sesquichloride, wherein the dialkyl aluminum monochloride has a formula R⁵₂AlCl and wherein the alkyl aluminum sesquichloride has a formula R⁵₃Al₂Cl₃ and wherein R⁵ is an alkyl radical having 1 to 10 carbon atoms, and wherein the component (c) is (C₂H₅)₃Al₂Cl₃ or (C₂H₅)₂AlCl or their mixtures.

16. The method according to claim 3, wherein the halogen containing silicon compound includes a halogen containing a silicon compound represented by a formula XₙSi(OR²)₄₋ₙ and wherein X is a halogen atom, and wherein R² is an alkyl group, and wherein n is in a range of 0-4, and wherein the component (d) is selected from a group comprising of SiCl₄, Si(OCH₃)Cl₃, and Si(OC₂H₅)₂Cl₂.

17. A method of synthesizing a homopolymer and a copolymer comprising steps of:
polymerising a monomer in presence of a Ziegler catalyst and a co-catalyst, wherein the polymerization is carried out at a temperature of 50° C. to 120° C. and at a pressure of 2 bar to 20 bars, and wherein the temperature is 70° C. to 90° C.

18. The method according to claim 17, wherein the monomer is 1-olefin wherein the 1-olefin has a formula R¹CH═CH₂, and wherein R¹ is hydrogen or an alkyl radical having 1 to 10 carbon atoms.

19. The method according to claim 17, wherein the co-catalyst is a chlorine free organoaluminum having a formula AlR⁶₃ and wherein R⁶ is an alkyl radical having 1 to 16 carbon atoms, and wherein the co-catalyst is selected from a group comprising of Al(C₂H₅)₃, Al(C₃H₇), Al(iC₄H₉)₃, Al(C₈H₁₇)₃, Al(C₁₂H₂₅)₃, Al(C₂H₂₅)(C₁₂H₂₅)₂ and Al(iC₄H₉)(C₁₂H₂₅)₂, and wherein the co-catalyst is Al(C₂H₅)₃.

20. The method according to claim 17, wherein the Ziegler catalyst is a reaction product of a component (a), a component (b), a component (c), together with at least two additional components, wherein the at least two additional components are a component (d) and a component (e);
wherein the component (a) is dispersed magnesium alkoxide or a dispersed mixture of magnesium alkoxide and silica;
wherein the component (b) is a transition metal compound of titanium, zirconium, vanadium and chromium, and wherein the component (b) is TiCl₄ or Ti (OR²)₄;
wherein the component (c) is a chlorine containing organoaluminum comprising a dialkyl aluminum monochloride and an alkyl aluminum sesquichloride, and wherein the dialkyl aluminum monochloride has a formula R⁵₂AlCl and wherein the alkyl aluminum sesquichloride has a formula R⁵₃Al₂Cl₃ and wherein R⁵ is an alkyl radical having 1 to 10 carbon atoms, and wherein the component (c) is (C₂H₅)₃Al₂Cl₃ or (C₂H₅)₂AlCl or their mixtures;
wherein the component (d) is a halogen containing a silicon compound represented by a formula XₙSi(OR²)₄₋ₙ and wherein X is a halogen atom, and wherein R² is an alkyl group, and wherein n is within arrange of 0-4, and wherein the component (d) is selected from a group comprising of SiCl₄, Si(OCH₃)Cl₃, and Si(OC₂H₅)₂Cl₂;
wherein the component (e) is an aliphatic primary halogenated hydrocarbons, and wherein the component (e) is selected from a group comprising of CCl₄, CHCl₃, CH₂Cl₂, CH₃CCl₃, CH₂ClC₂H₅, benzyl chloride and combination thereof, and wherein the component (e) is CCl₄, CHCl₃.
